(19) United States
(12) Patent Application Publication
(10) Pub. No.: US 2010/0078122 A1
(43) Pub. Date: Apr. 1, 2010

(54) METHODS OF MANUFACTURING FLUID STORAGE COMPONENTS

(75) Inventors: Joerg Zimmermann, Vancouver (CA); Tristan Sloan, Vancouver (CA); Mikhail Gurin, Burnaby (CA); Laura Gill, North Vancouver (CA)

Correspondence Address: SCHWEGMAN, LUNDBERG & WOESSNER, P.A., P.O. BOX 2938, MINNEAPOLIS, MN, 55402, US

(73) Assignee: Angstrom Power Incorporated, North Vancouver (CA)

(21) Appl. No.: 12/571,883

(22) Filed: Oct. 1, 2009

Related U.S. Application Data
(60) Provisional application No. 61/101,731, filed on Oct. 1, 2008.

(51) Int. Cl. B32B 27/04; D04H 1/64; B29C 67/04

(52) U.S. Cl. 156/242; 264/128; 264/117

(57) ABSTRACT

Embodiments of the invention relate to a method of manufacturing a fluid enclosure. The method includes reducing the size of active material particles sufficient to provide a maximum active material particle size substantially within the same order of size as the active material particle decrepitation size, contacting the particles with a binder sufficient to provide a mixture, pressing the mixture sufficient to provide a compacted mixture, heating the compacted mixture sufficient to form a fluid storage component and conformably coupling an outer enclosure wall to the fluid storage component sufficient to provide a fluid enclosure.

### CLAIM OF PRIORITY

This patent application claims the benefit of priority of Joerg Zimmermann et al. U.S. Provisional Patent Application Ser. No. 61/101,731, (Attorney Docket Number 2269.084PV3), which was filed on Oct. 1, 2009, and which is incorporated herein by reference in its entirety.

### BACKGROUND

Small scale energy systems, such as micro fuel cell systems, may require fluid storage components with high energy densities and adaptability for the unique space and size requirements of such a small system. Micro systems are often limited by the size and flexibility of the fluid components on which they depend. Traditional fluid storage components, such as enclosures, are difficult to manufacture and design at a micro level due to the high pressure and instability of fluids used as an energy source in a micro system.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a block flow diagram of a method of manufacturing a fluid storage component, according to some embodiments.

FIG. 2 illustrates a block flow diagram of a method of manufacturing a fluid enclosure, according to some embodiments.

### SUMMARY

Embodiments of the invention relate to a method of manufacturing a fluid storage component. The method includes reducing the size of active material particles sufficient to provide a maximum active material particle size substantially within the same order of size as the active material particle decrepitation size, contacting the particles with a binder sufficient to provide a mixture, pressing the mixture sufficient to provide a compacted mixture and heating the compacted mixture sufficient to form a fluid storage component.

Embodiments of the invention relate to a method of manufacturing a fluid enclosure. The method includes reducing the size of active material particles sufficient to provide a maximum active material particle size substantially within the same order of size as the active material particle decrepitation size, contacting the particles with a binder sufficient to provide a mixture, pressing the mixture sufficient to provide a compacted mixture, heating the compacted mixture sufficient to form a fluid storage component and conformably coupling an outer enclosure wall to the fluid storage component sufficient to provide a fluid enclosure.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to methods of manufacturing fluid storage components. Fluid storage components may include fluid storage materials, structural fillers, composite storage materials or fluid enclosures, for example. Such components may be utilized in small or micro scale energy systems, such as fuel cell systems. Embodiments of the invention relate to manufacturing methods such as the separation of pressing and sintering to improve manufacturability, agglomeration to improve handling and safety, and a higher sintering temperature to increase enclosure strength. Activation and cycling of the fluid contact/removal prior to sintering relieves stress caused by activation. Such cycling can be done while forming a fluid storage component or during the forming of an enclosure. The fluid may be substantially removed after the activation step in order to prevent enclosure deformities.

### DEFINITIONS

As used herein, “activating” refers to contacting a fluid storage component or enclosure with a fluid capable of being stored. As an example, a metal hydride may be activated by being exposed to hydrogen. The fluid may chemically or physically interact with the component, such that activation occurs. Activating may also include the removal or substantial removal of the fluid from the component.

As used herein, “sintering” refers to heating a solid or mixture by heating, with or without melting one or more of the constituents, to form a cohesive mass. Sintering may form enhanced physical or chemical bonds between substances in a mixture or between particles or molecules of a uniform substance, for example. According to the embodiments of the present invention, sintering may be accomplished at a higher heat than previously utilized. Sintering may be utilized in combination with activation, for example. Sintering may occur at temperatures of about 130° C. to about 220° C., for example.

As used herein, “fusing” or “fused” refers to chemically or physically contacting, such that a stronger bond is formed than was in existence previously. Fusing increases the strength or amount of interaction between materials or portions of materials.

As used herein, “reducing” refers to decreasing the size of one or more particles, such as active material particles. The size may be decreased in terms of mass or volume of particle, for example.

As used herein, “heating” refers to altering the temperature of a substance. For example, the temperature of a mixture may be increased by applying heat or infrared light. Pressing and heating may be performed simultaneously, such as in hot press.

As used herein, “pressing” refers to the application of pressure. The application of pressure may be direct, as in pressing with a mechanical press or applying compaction pressure. Pressing may also cause compaction by utilizing an rigid mold in a mechanical press, using a compliant mold in an isostatic press, by restricting a mixture in a rigid mold during activation and allowing active particle expansion to provide compaction pressure, for example. Pressing may also include application of pressure to the substance directly and by this process, forcing the fluid storage component into a mold, such as by injection molding.

As used herein, “fluid” refers to a continuous, amorphous substance whose molecules move freely past one another and that has the tendency to assume the shape of its container. A fluid may be a gas, liquefied gas, liquid or liquid under pressure. Examples of fluids include hydrogen, methanol, ethanol, formic acid, butane, liquid borohydride formulations (e.g., borohydride compound and one or more alkali metal hydroxides), etc.

As used herein, “fluid storage component” refers to material capable of storing a fluid. The fluid storage component may store a fluid physically or chemically, for example. A composite hydrogen storage material is an example of a fluid storage component. Fluid storage components may also include structural fillers.

As used herein, “active material particles” refer to material particles capable of storing hydrogen or another fluid or to material particles that may occlude and desorb hydrogen or another fluid, such as metal hydrides, for example. The active material may be a metal, metal alloy or metal compound capable of forming a metal hydride when in contact with hydrogen. For example, the active material may be LaNi₅, FeTi, an alloy containing mischmetal, a mixture of metals or an ore, such as MmNi₅, wherein Mm refers to a mixture of lanthanides. The active material particles may occlude hydrogen by chemisorption, physisorption or a combination thereof. Active material particles may also include silicas, aluminas, zeolites, graphite, activated carbons, nano-structured carbons, micro-ceramics, nano-ceramics, boron nitride nanotubes, palladium-containing materials or combinations thereof.

As used herein, “structural filler” refers to a material with a sufficient mechanical strength to withstand the internal pressure of a fluid enclosure, when pressurized with a fluid. Structural fillers may be solid. Structural fillers may include metallic or plastic lattices, composite hydrogen storage materials, clathrates, nano-structured carbon foams, aerogels, zeolites, silicas, aluminas, graphite, activated carbons, micro-ceramics, nano-ceramics, boron nitride nanotubes, borohydride powder, palladium-containing materials or combinations thereof, for example.

As used herein, “conformably coupled” refers to forming a bond that is substantially uniform between two components and are attached in such as way as to chemically or physically bind in a corresponding shape or form. A structural filler or fluid storage component may be conformably coupled to an outer enclosure wall, for example, in which the outer enclosure wall chemically or physically binds to the structural filler or fluid storage component and takes its shape.

As used herein, “outer enclosure wall” refers to the outermost layer within a fluid enclosure that serves to at least partially slow the diffusion of a fluid from the fluid enclosure. The outer enclosure wall may include multiple layers of the same or differing materials. The outer enclosure wall may include a polymer or a metal, for example.

As used herein, “feature” refers to a fluidic component associated with a fluid enclosure. A feature may act to communicate between an enclosure and an external device or ambient environment, to observe or control a fluid, or act as a structural component. Examples of a feature may be a valve, regulator, pressure relief device, flow element, cap, fitting, vent, tube, etc.

As used herein, “structural feature” refers to an element that may be associated with the shape, positioning or alignment of the structural filler, fluid storage component, the outer enclosure wall or the overall fluid enclosure. A structural feature may be formed to allow space for external components or to create more efficient alignment between the fluid enclosure and an external device, for example. Structural features include convex protrusions, concave recesses, mountings, flanges, fittings, bosses, smoothed or radiused corners, etc.

As used herein, “metal hydride particles” or “metal hydrides” refer to metal or metal alloy particles that are capable of forming metal hydrides when contacted with hydrogen. Examples of such metal or metal alloys are LaNi₅, FeTi, Mg₂Ni and ZrV₂. Such compounds are representative examples of the more general description of metal hydride compounds: AB, AB₂, A₂B, AB₅ and BCC, respectively. When bound with hydrogen, these compounds form metal hydride complexes, such as MgH₂, Mg₂NiH₄, FeTiH₂ and LaNi₅H₆, for example. Examples of metals used to form metal hydrides include vanadium, magnesium, lithium, aluminum, calcium, transition metals, lanthanides, and intermetallic compounds and solid solutions thereof.

As used herein, “composite hydrogen storage material” refers to active material particles mixed with a binder, wherein the binder immobilizes the active material particles sufficient to maintain relative spatial relationships between the active material particles. Examples of composite hydrogen storage materials are found in commonly-owned U.S. patent application Ser. No. 11/379,970, filed Apr. 24, 2006, whose disclosure is incorporated by reference herein in its entirety.

As used herein, “contacting” refers to physically, chemically, electrically touching or within sufficiently close proximity A fluid may contact an enclosure, in which the fluid is physically forced inside the enclosure, for example.

As used herein, “fluid enclosure” may refer to a fluid enclosure including a fluid storage component and an outer enclosure wall, conformably coupled to the fluid storage component. Examples of such a fluid enclosure are found in commonly-owned U.S. Pat. No. 7,563,305, whose disclosure is incorporated by reference herein in its entirety.

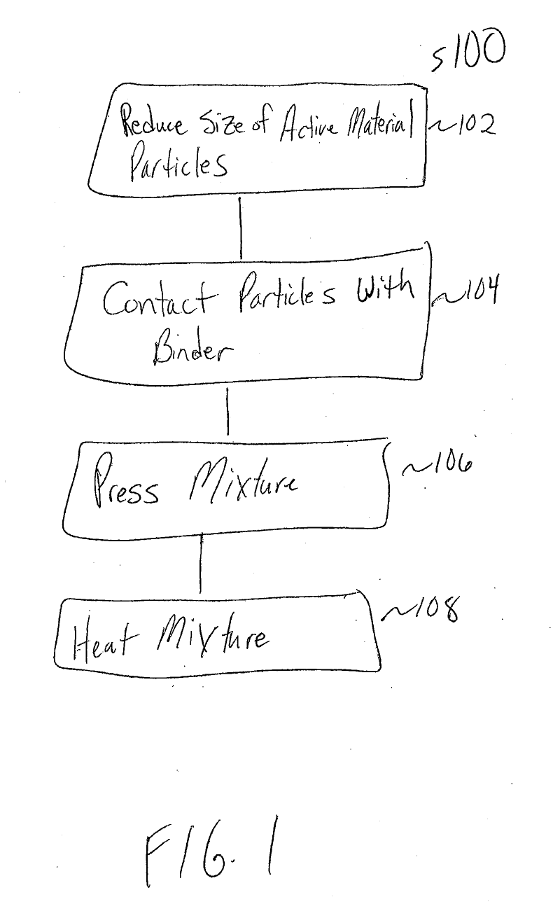

Referring to FIG. 1, a block flow diagram 100 of a method of manufacturing a fluid storage component is shown, according to some embodiments. The size of active material particles may be reduced 102 sufficient to provide a maximum active material particle size substantially within the same order of size as the active material particle decrepitation size. The particle size distribution of the particles may be selected to maximize the efficient packing of particles. The particles may then be contacted 104 with a binder, sufficient to provide a mixture. The mixture may then be pressed 106 to provide a compacted mixture. The compacted mixture may then be heated 108. The mixture may be pressed 106 and heated 108 at the same time.

Reducing 102 may be accomplished by grinding, milling, tumbling, and decrepitation through reacting with hydrogen and combinations thereof, for example. Reducing 102 may be done by utilizing a planetary mill, jet mill or tumble apparatus. Reducing 102 may also be done by reactive milling or decrepitation through reacting with a fluid, such as hydrogen. Reducing may be done by a combination of reactive milling and physical milling. The active material particles may be contacted with a fluid, such as hydrogen, which induces stress and strain on the particles, causing particles to decrepitate, or break up into smaller particles. When active material particles are contacted with a fluid repeatedly over a period of time, they may naturally decrepitate to a point where the average particle size will stabilize, sometimes known as a “terminal particle size”. Different active materials will possess an average terminal particle size which is characteristic of the particular material, and may vary depending on the active material in question. This stabilized average particle size is referred to herein as the “decrepitation size” of the active material particles. The particles may be reduced 102 until a substantial proportion of particles have a particle size substantially within the same order of magnitude as the active material particle decrepitation size. By having a controlled particle size distribution, the particles may be more conducive to efficient packing, allowing for increased packing densities. Reducing 102 may be done in an inert atmosphere. Reducing 102 may be performed simultaneously with contacting 104.

Contacting 104 with a binder may include mixing, tumbling, stiffing, combining in solution, or a combination thereof. Tumbling may include contacting the particles and binder in a V-shaped blender, for example. Particles may be contacted in an inert environment, such as a helium, nitrogen, or argon environment, to prevent unwanted physical or chemical reactions with unwanted environment constituents. If contacted in solution, the binder may be dissolved and contacted with the particles, followed by evaporation of the solvent. Evaporation may then produce a conglomerated mixture, such as a cake.

The mixture may be pressed 106 by applying a pressure from about 50 MegaPascals to about 500 MegaPascals, from about 100 MegaPascals to about 400 MegaPascals, or from about 200 MegaPascals to about 300 MegaPascals, for example. The mixture may be pressed 106 to a “hard stop,” in which the mixture is pressed until the mechanism touches a pre-set solid form, thus ensuring a high level of consistency in applying pressure and maintaining shape. The mixture may also be pressed via application of a set, predetermined applied pressure, without the use of a hard stop. Alternatively, an adapted/non adapted injection molding technique may be used. Pressing 106 may be performed within a mold. Internal or external features, or parts thereof, may be formed during the pressing process via internal mold featuring.

Heating 108 may include sintering, for example. Heating 108 may be from about 100° C. to about 350° C. or from about 155° C. to about 290° C., for example. Heating may occur in combination with pressing, such as through use of a heated press to sinter the component while pressing the particles into a desired shape. The component may be contacted with a fluid and then the fluid removed by vacuum in a cyclic manner over repeated steps. The component may be heated under vacuum and then exposed to an inert gas while raising the pressure. The inert gas, such as helium, may be removed before re-introducing the fluid, such as hydrogen. The component may then be cooled under vacuum and the process or parts of the process repeated. Such cycling and sintering removes substantially more fluid from the component, thus preventing manufacturing deformities in the component.

After contacting 104, the optional step of agglomerating the mixture may be performed. Agglomerating may comprise increasing the size of particles in the mixture, which may increase the ease of handling and further processing. Agglomerating may include heating and agitating particles of the mixture. Agglomerating may include heating to provide a fused mixture and agitating the mixture to break up the mixture into coarse particles. Agglomeration may include application of pressure and movement with no applied heat during a cold rolling process.

Optionally, and after the step of heating, the compacted or conglomerated mixture may be activated. In other embodiments, the active material particles may be activated during the step of reducing 102 via reaction milling. The active material particles, whether in a powder form or in a compacted mixture, may be activated by contacting with a fluid, such as hydrogen. The fluid may then be removed from the particles. Contacting with fluid and fluid removal may be repeated several times, such as about 30 times, about 20 times, about 10 times, about 5 times or 2 times, for example. When activating the mixture, stress, expansion and strain may cause fractures and further particle breakdown. These stresses, expansion and strains may be irreversible. Further, some of the fluid may be permanently bound in the mixture, or fluid storage component, during activation. The activation may help stabilize the component for use. Contacting and removal may occur in a pressure vessel, for example.

The fluid storage component may be laminated with a second fluid storage component to form a laminated fluid storage component, for example. Each fluid storage component may form one half of the final component. Internal features may be formed during the lamination. For example, each fluid storage component may be pressed or heated in a mold. The mold may include a topography or geometry, such that when two fluid storage components are laminated or otherwise contacted, internal features are formed. The features may be flow field features, such as channels or grooves. Lamination may be performed by using an adhesive. The adhesive may be manufactured of the same or similar material as the binder, for example.

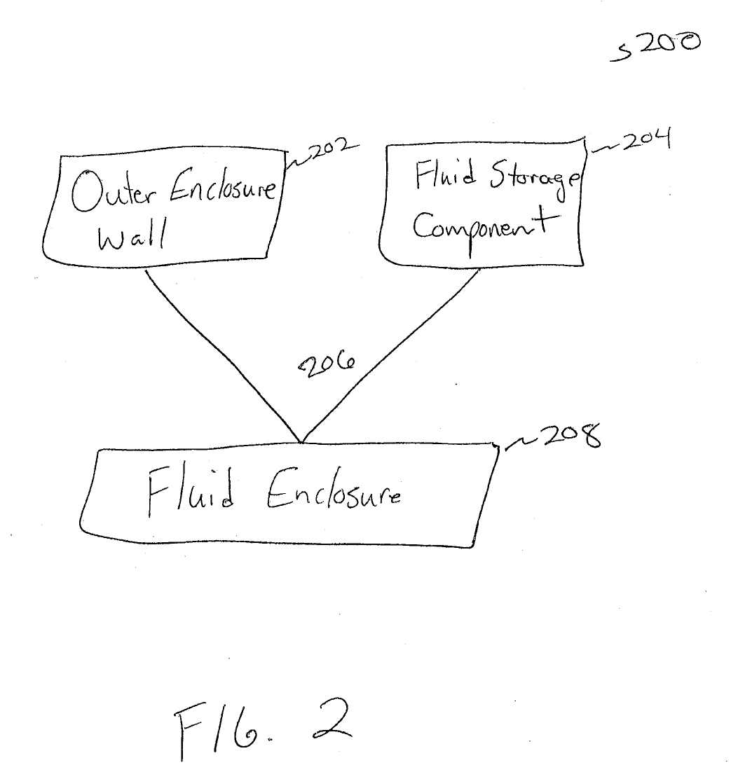

Referring to FIG. 2, a block flow diagram 200 of a method of manufacturing a fluid enclosure is shown, according to some embodiments. An outer enclosure wall 202 may be conformably coupled 206 to fluid storage component 204 or more than one component, sufficient to provide a fluid enclosure.

Conformably coupling 206 may include solution casting the wall to the fluid storage component 204. Solution casting may include the steps of dissolving a wall material in a solution, applying the solution to the fluid storage component and heating the fluid storage component. The wall material may be substantially the same material as the binder in the fluid storage component. Applying may be repeated multiple times. The fluid storage component may undergo grinding, sanding, tumbling, trimming, cutting, milling, etc. in order to alter its shape, texture or topography, such to optimize the application of the solution. The corners of the fluid storage component may be rounded, for example. After application, the component may be sintered.

Conformably coupling 206 may include molding an outer enclosure wall shell to the fluid storage component 204. Molding may include heating the fluid storage component and outer enclosure wall shell in a mold. Before, during or after heating, the optional step of pressing may be performed. Pressing may include applying compaction pressure, for example. After pressing, the mold may be sintered.

Conformably coupling 206 may include vacuum forming the outer enclosure wall to the fluid storage component 204. Vacuum forming may include contacting a first side of the fluid storage component with a first sheet of wall material, heating the first sheet under vacuum sufficient to form a first outer enclosure wall, contacting a second side of the fluid storage component with a second sheet of wall material and heating the second sheet under vacuum sufficient to form a second outer enclosure wall. After each step of heating, the excess wall material may be removed from the component, such as by trimming. The component may be sintered after the vacuum molding. Heating may include contacting with infrared light, for example. In some embodiments, wall material may be formed into preformed shell halves that are formed by vacuum forming or molding. In such embodiments, the preformed shell halves may then be vacuum formed to the fluid storage component by applying a vacuum to the fluid storage component and sintering the component. The application of a vacuum to the fluid storage component during sintering enables the conformable coupling of the preformed shell halves to the fluid storage component.

Prior to vacuum forming or other methods of conformably coupling 206, the fluid storage component 204 may undergo a surface preparation treatment in order to facilitate the contacting of the outer enclosure wall. Surface preparation treatment may include sanding, tumbling or other means of altering the texture or topography of the component. The treatment may also include applying a coating of material of the same type as the binder to the component, prior to conformably coupling the outer enclosure wall. The coating may be applied via spraying, dipping, painting, etc.

Contacting may include adjusting the thickness of the first and second sheet of wall material such that when contacted, they form a wall with substantially the same thickness on all edges of the component. In some embodiments, the wall material may be preformed into molded shapes with controlled and/or varied thickness to form a wall around the component. Adjusting the thickness may be performed by controlling the geometry of a mold in contact with the fluid storage component. The wall material may be substantially the same material as the binder in the fluid storage component. The fluid storage component may undergo grinding, trimming, cutting, tumbling, milling, etc. in order to alter its shape, texture or topography, such to optimize the application of the sheets of wall material. The corners of the fluid storage component may be rounded, for example.

Conformably coupling 206 may include powder coating the outer enclosure wall 202 to the fluid storage component 204. Either the outer enclosure wall 202 or the fluid storage component 204 may be electrostatically charged. After powder coating, the step of heating may be performed. The coating may occur in multiple steps. The component 204 may be sintered.

Before or after conformably coupling 206, one or more features or structural features may be formed in the outer enclosure wall 202, the fluid storage component 204 or both. Features include fluidic components associated with a fluid enclosure or fluid storage component. A feature may act to communicate between an enclosure and an external device or ambient environment, to observe or control a fluid, or act as a structural component. Examples of a feature may be a valve, regulator, pressure relief device, flow element, cap, fitting, vent, tube or other microfluidic components. For example, a feature that provides a fluid connection to the enclosure may comprise a metal or plastic tube which is interference fitted into a plastic plug. To construct such a feature, a port may be formed in the enclosure. The port may be constructed such that the initial portion of the port has an enlarged diameter. An annular plug with a matching diameter to the enlarged port may then be glued into the port. The head of the annular plug may then be melted against the wall of the fluid enclosure, creating a gas-tight seal between the plug and the enclosure. A tube may then be press-fit into the annular plug.

In one example, the feature may be constructed as follows: the first section (i.e. about 3 mm) of the enclosure's port hole is drilled out to increase its diameter. An annular plug (i.e., with an inner diameter of 0.45 mm, an outer diameter of 1.4 mm and a length of 5 mm) may be glued into the enlarged port hole using an adhesive. In some embodiments, an adhesive consisting of 2500 grade Kynarflex dissolved in acetone may be used. For the gluing process a dowel may be inserted (i.e., 0.45 mm) into the inner diameter of the plug to preserve its geometry. Once the glue has been allowed to dry, a heat sealer may be used to flatten the head of the plug and melt it against the wall of the enclosure. Melting the plug against the enclosure wall may ensure that a gas tight seal is formed between the plug and the enclosure. In this example the plug and the enclosure wall may be both made from 2500 grade Kynarflex. The dowel may now be removed replaced with a tube (i.e., 0.5 mm OD) that is press fit into place. The interference fit between the plug and the tube (i.e., 0.5 mm) forms a gas tight seal. Grease may be applied to the tube prior to insertion to ensure a good seal.

A structural feature refers to an element that may be associated with the shape, positioning or alignment of the structural filler or fluid storage component, the outer enclosure wall or the overall fluid enclosure. A structural feature may be formed to allow space for external components or to create more efficient alignment between the fluid enclosure and an external device, for example. Structural features include convex protrusions, concave recesses, mountings, flanges, fittings, bosses, smoothed or radiused corners, etc. A feature may be one that increases the flow field of the fluid, for example. Such internal features may be channels or grooves.

A fluid enclosure may be manufactured according to the following method: reducing the size of active material particles sufficient to provide a maximum active material particle size substantially within the same order of size as the active material particle decrepitation size, contacting the particles with a binder sufficient to provide a mixture, pressing the mixture sufficient to provide a compacted mixture, heating the compacted mixture, sufficient to fuse the binder and the active material particles to form a fluid storage component and conformably coupling an outer enclosure wall to the fluid storage component sufficient to provide a fluid enclosure.

Further, during or after the step of conformably coupling, the optional step of heating the fluid enclosure sufficient to strengthen the bond between the enclosure wall and the fluid storage component may be performed. Before conformably coupling, one or more features or structural features may be formed in the fluid storage component or the outer enclosure wall, for example.

In another embodiment, a method of manufacturing a fluid enclosure, includes reducing the size of active material particles sufficient to provide a maximum active material particle size substantially within the same order of size as the active material particle decrepitation size, contacting the particles with a binder sufficient to provide a mixture, pressing the mixture, conformably coupling an outer enclosure wall to the fluid storage component sufficient to provide a fluid enclosure and heating the fluid enclosure, sufficient to strengthen the bond between the enclosure wall and the fluid storage component and to fuse the binder and the active material particles to form a fluid storage component.

The above description is intended to be illustrative, and not restrictive. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A method of manufacturing a fluid storage component, comprising:
reducing the size of active material particles, sufficient to provide a maximum active material particle size substantially within the same order of size as the active material particle decrepitation size;
contacting the particles with a binder, sufficient to provide a mixture;
pressing the mixture, sufficient to provide a compacted mixture; and
heating the compacted mixture, sufficient to fuse the binder and the active material particles to form a fluid storage component.

2. The method of claim 1, further comprising laminating multiple fluid storage components, sufficient to provide a laminated fluid storage component.

3. The method of claim 2, wherein the laminated fluid storage component comprises features.

4. The method of claim 3, wherein the features comprise flow field features.

5. The method of claim 1, wherein reducing comprises one or more of grinding, milling, tumbling, and decrepitation through reacting with hydrogen.

6. The method of claim 1, wherein contacting comprises mixing, tumbling, stirring, combining in solution, or a combination thereof.

7. The method of claim 1, wherein reducing and contacting are performed simultaneously.

8. The method of claim 1, wherein heating comprises sintering.

9. The method of claim 1, further comprising after contacting, agglomerating the mixture.

10. The method of claim 1, wherein pressing comprises applying compaction pressure to the mixture within a mold, or forcing the mixture into a mold via applied pressure.

11. The method of claim 10, wherein the mold is structured to provide features or parts of features.

12. The method of claim 1, further comprising activating the fluid storage component.

13. The method of claim 12, wherein activating comprises contacting the component with a fluid.

14. The method of claim 13, further comprising removing the fluid.

15. The method of claim 14, further comprising after removing, repeatedly contacting the component with fluid and removing the fluid

16. A method of manufacturing a fluid enclosure, the method comprising:
conformably coupling an outer enclosure wall to a fluid storage component;
wherein conformably coupling comprises molding an outer enclosure wall to a fluid storage component.

17. The method of claim 16, wherein molding comprises heating the fluid storage component and outer enclosure wall in a mold.

18. The method of claim 16, wherein molding comprises vacuum forming an outer enclosure wall to the fluid storage component.

19. The method of claim 18, further comprising pressing.

20. The method of claim 19, further comprising sintering.

21. The method of claim 16, further comprising before conformably coupling, abrading the surface of the fluid storage component.

22. The method of claim 18, wherein vacuum forming comprises:
contacting a first side of the fluid storage component with a first sheet of wall material;
heating the first sheet under vacuum, sufficient to form a first outer enclosure wall;
contacting a second side of the fluid storage component with a second sheet of wall material; and
heating the second sheet under vacuum, sufficient to form a second outer enclosure wall.

23. The method of claim 22, wherein the wall material comprises substantially the same material as a binder in the fluid storage component.

24. The method of claim 18, wherein vacuum forming comprises:
forming a shell comprising one or more components;
sealing the fluid storage component within the shell;
sintering the assembly of the fluid storage component and the shell while applying a vacuum to the inside of the assembly such that the shell conformally adheres to the fluid storage component.

25. The method of claim 16, wherein the fluid storage component is formed by:
reducing the size of active material particles, sufficient to provide an average active material particle size substantially within the same order of size as the active material particle decrepitation size;
contacting the particles with a binder, sufficient to provide a mixture;
pressing the mixture, sufficient to provide a compacted mixture; and
heating the compacted mixture, sufficient to fuse the binder and the active material particles.
